(19) United States
(12) Patent Application Publication
(10) Pub. No.: US 2015/0222150 A1
(43) Pub. Date: Aug. 6, 2015

(54) ELECTRIC MOTOR

(71) Applicants: DENSO CORPORATION, Kariya-city (JP); ASMO CO., LTD., Kosai-city (JP)

(72) Inventors: Shinji MAKITA, Kakamigahara-shi (JP); Yasuhide ITO, Toyokawa-shi (JP); Tomohiro AOYAMA, Toyohashi-shi (JP)

(21) Appl. No.: 14/615,046

(22) Filed: Feb. 5, 2015

(30) Foreign Application Priority Data
Feb. 6, 2014 (JP) 2014-020895

(51) Int. Cl. H02K 1/16; H02K 1/27

(52) U.S. Cl. CPC H02K 1/16; H02K 1/278

(57) ABSTRACT

An electric motor includes a rotor including magnetic poles whose number of pole pairs is P, P being a natural number, and a stator including windings. The stator includes (3/2)×P large teeth with a first pole pitch and (3/2)×P small teeth with a second pole pitch smaller than the first pole pitch. The large teeth and the small teeth are disposed so as to circumferentially alternate. The windings are wound concentratedly only on the large teeth. When the first pole pitch in electrical angle is X and the second pole pitch in electrical angle is Y, X is in a range from 144 to 180 degrees, and Y is equal to (240−X) degrees. The circumferentially adjacent windings are supplied with currents having a phase difference of 120 degrees in electrical angle therebetween, respectively.

This application claims priority to Japanese Patent Application No. 2014-20895 filed on Feb. 6, 2014, the entire contents of which are hereby incorporated by reference.

### BACKGROUND OF THE INVENTION

1. Field of the Invention

The present invention relates to a concentrated winding motor.

2. Description of Related Art

It is known that the circumferential distribution of a magnetic flux density (referred to as the “flux wave” hereinafter) generated by a rotor of a synchronous motor contains harmonic components, and accordingly an induced voltage is distorted, causing a torque ripple. Japanese Patent Application Laid-open No. H11-234990 describes an electric motor configured to reduce distortion of its induced voltage to reduce its torque ripple.

The electric motor described in this patent document has a structure in which, when the number of the pole pairs of the rotor is P, the stator includes (3/2)×P large teeth with a large circumferential pole pitch and (3/2)×P small teeth with a small circumferential pole pitch that are disposed alternately, and windings are wound concentratedly only on the large teeth. In this electric motor, to reduce its torque ripple by reducing the induced voltage distortion, the circumferential positions of the teeth are shifted relative to the magnetic poles of the same phase.

However, in this structure, since the periodicity of the pole arrangement is degraded, causing imbalance of the radial force to increase, the vibration of the electric motor increases. In addition, since the winding space is reduced due to shift of the circumferential positions of the teeth, the performance of the electric motor is lowered.

### SUMMARY

An exemplary embodiment provides an electric motor including:

a rotor including magnetic poles whose number of pole pairs is P, P being a natural number; and

a stator including windings,

wherein

the stator includes (3/2)×P large teeth with a first pole pitch and (3/2) ×P small teeth with a second pole pitch smaller than the first pole pitch, the large teeth and the small teeth being disposed so as to circumferentially alternate,

the windings are wound concentratedly only on the large teeth,

when the first pole pitch in electrical angle is X, X is in a range from 144 to 180 degrees,

when the second pole pitch in electrical angle is Y, Y is equal to (240−X) degrees, and

the circumferentially adjacent windings are supplied with currents having a phase difference of 120 degrees in electrical angle therebetween, respectively.

According to the exemplary embodiment, there is provided a concentrated winding motor capable of reducing its induced voltage distortion without degrading the periodicity of the magnetic pole arrangement of the stator thereof.

Other advantages and features of the invention will become apparent from the following description including the drawings and claims.

### BRIEF DESCRIPTION OF THE DRAWINGS

In the accompanying drawings:

FIG. 1 is a diagram showing the overall structure of an electric motor according to an embodiment of the invention;

FIG. 2 is a graph showing the levels of components of different orders of the magnetic flux density of the electric motor when the flux wave has a waveform of a 180-degree rectangular wave;

FIG. 3 is a graph showing the levels of components of different orders of the magnetic flux density of the electric motor when the flux wave has a waveform of a 150-degree trapezoidal wave;

FIG. 4 is a graph showing the levels of components of different orders of the magnetic flux density of the electric motor when the flux wave has a waveform of a 90-degree trapezoidal wave;

FIG. 5A is a diagram showing relationships between the levels of the components of the different orders of an induced voltage and the pole pitch of the large teeth of the electric motor when the flux wave has the waveform of the 180-degree rectangular wave;

FIG. 5B is a diagram showing a relationship between the distortion factor of an induced voltage and the pole pitch of the large teeth of the electric motor when the flux wave has the waveform of the 180-degree rectangular wave;

FIG. 6A is a diagram showing relationships between the levels of the components of the different orders of an induced voltage and the pole pitch of the large teeth of the electric motor when the flux wave has the waveform of the 150-degree trapezoidal wave;

FIG. 6B is a diagram showing a relationship between the distortion factor of the induced voltage and the pole pitch of the large teeth of the electric motor when the flux wave has the waveform of the 150-degree trapezoidal wave;

FIG. 7A is a diagram showing relationships between the levels of the components of the different orders of an induced voltage and the pole pitch of the large teeth of the electric motor when the flux wave has the waveform of the 90-degree trapezoidal wave;

FIG. 7B is a diagram showing a relationship between the distortion factor of the induced voltage and the pole pitch of the large teeth of the electric motor when the flux wave has the waveform of the 90-degree trapezoidal wave; and

FIG. 8 is an enlarged view of main parts of the electric motor.

### PREFERRED EMBODIMENTS OF THE INVENTION

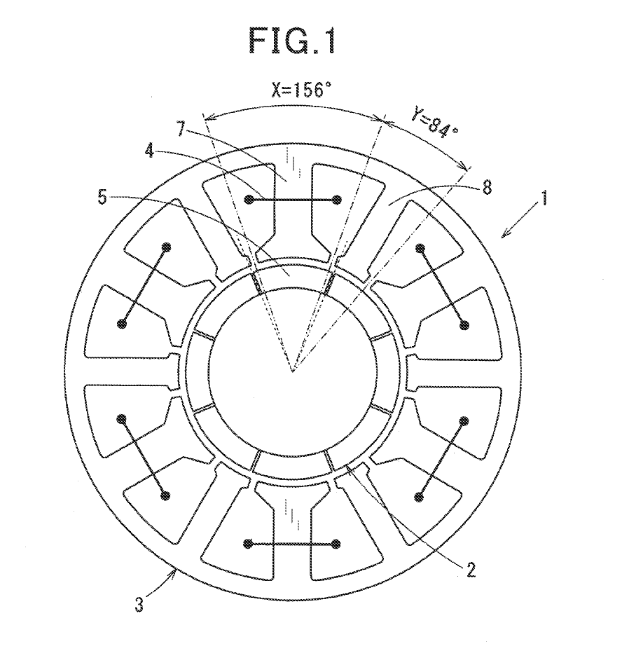

FIG. 1 is a diagram showing the overall structure of an electric motor 1 according to an embodiment of the invention. As shown in FIG. 1, the electric motor 1 is of the inner rotor type in which a rotor 2 is disposed at the radially inner side and a stator 3 is disposed at the radially outer side. A three-phase current is supplied to windings 4 of the stator 3. The rotor 2, which is of the surface magnet type, includes permanent magnets 5 whose N poles are exposed from the outer surface of the rotor, and permanent magnets 5 whose S poles are exposed from the surface of the rotor such that they circumferentially alternate. In this embodiment, the number P of the pole pairs is 4.

The stator 3 includes six (=(3/2)×4) large teeth 7 with a large pole pitch X and six small teeth 8 with small pole pitch Y which are disposed so as to circumferentially alternate. The windings 4 are wound concentratedly only on the large teeth 7. The pole pitch X of the large teeth 7 is 156 degrees in electrical angle which is in the range between 144 degrees and 166.2 degrees. The pole pitch Y of the small teeth 7 is 84 (=240−156) degrees in electrical angle. The circumferentially adjacent windings 4 are supplied with currents having a phase difference of 120 degrees in electrical angle therebetween.

The reason why the pole pitch X is set to 156 degrees is explained in the following. The value of the pole pitch X is determined in view of reducing harmonic components of the flux wave to thereby reduce the torque ripple due to an induced voltage distortion of the electric motor 1. Since the flux wave contains various harmonic components, it is preferable to determine the value of the pole pitch X such that the induced voltage distortion caused by the sum of these harmonic components becomes minimum.

The inventors of the present invention carried out a correlation test to find out a correlation between the pole pitch X and the effect of the harmonic components on the induced voltage for each of the case where the flux wave is a 180-degree rectangular wave, the case where it is a 150-degree trapezoidal wave and the case where it is a 90-degree trapezoidal wave. In this test, a distortion defined below was used as a parameter indicative of the effect of the harmonic components. The distortion was obtained by calculating the sum of the squares of the fifth, seventh eleventh and thirteenth harmonic components, and calculating a ratio of the square root of the sum to the fundamental component.

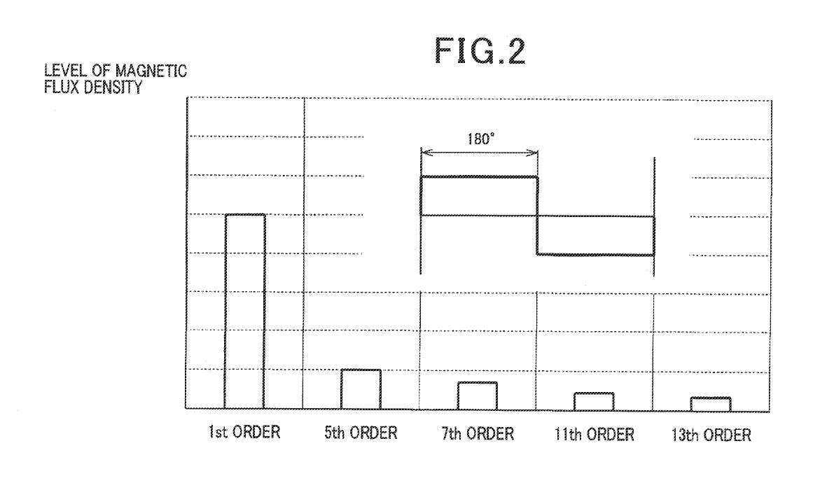

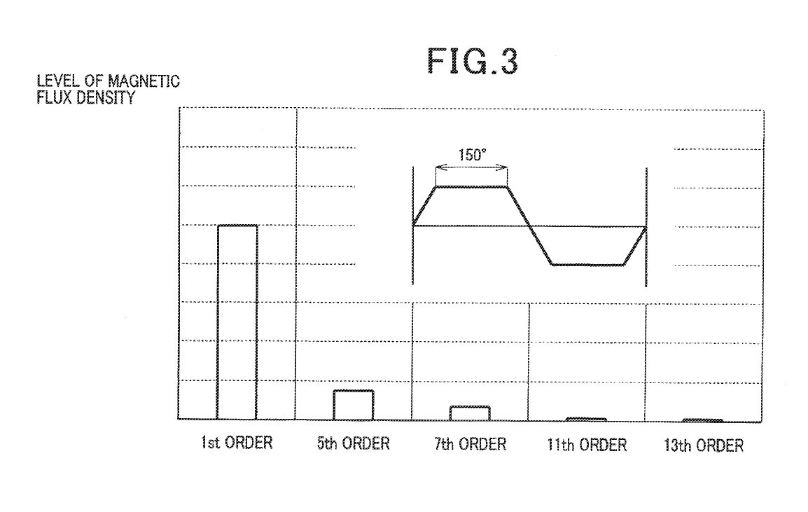

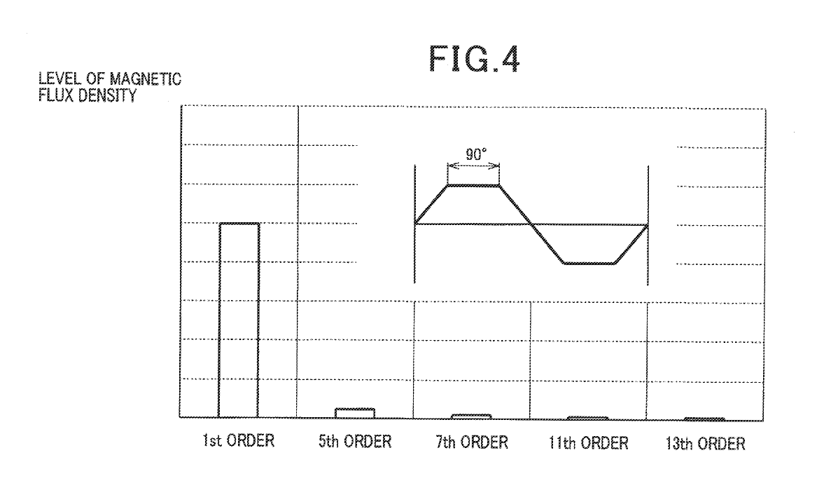

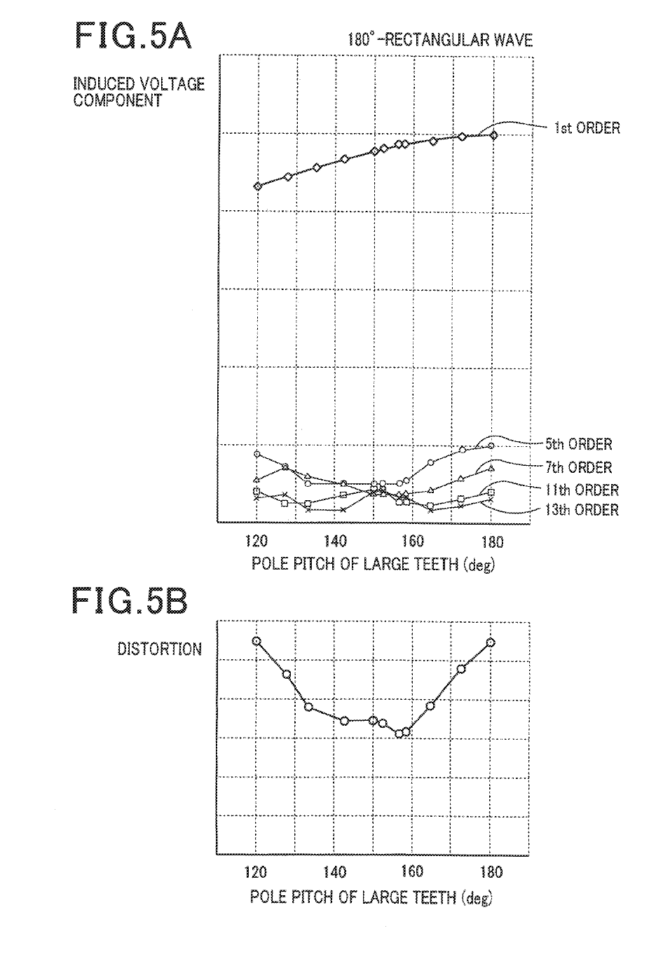

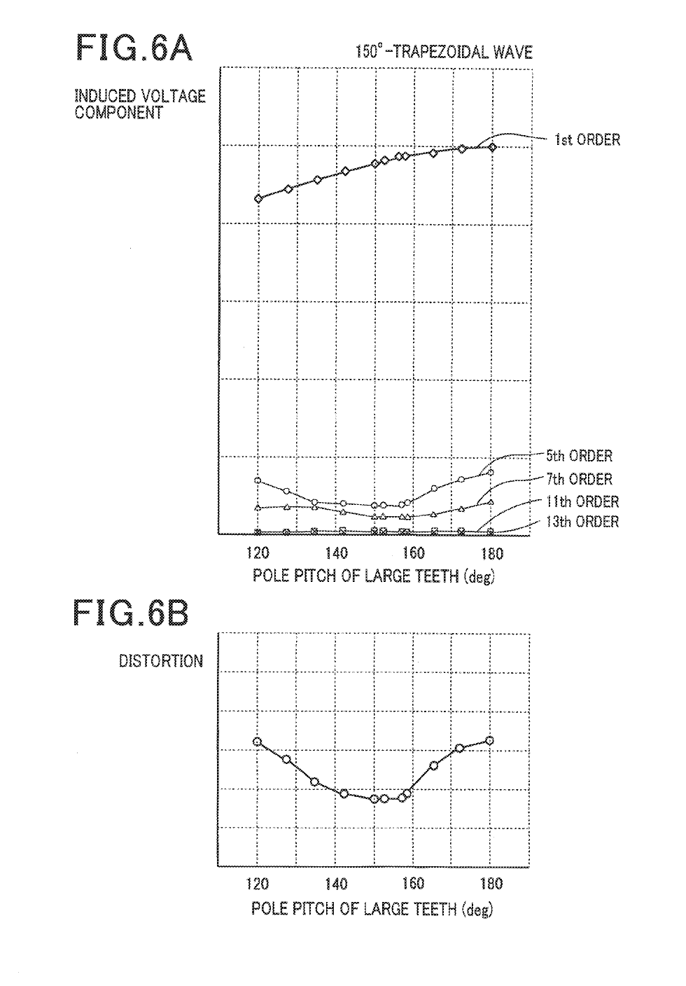

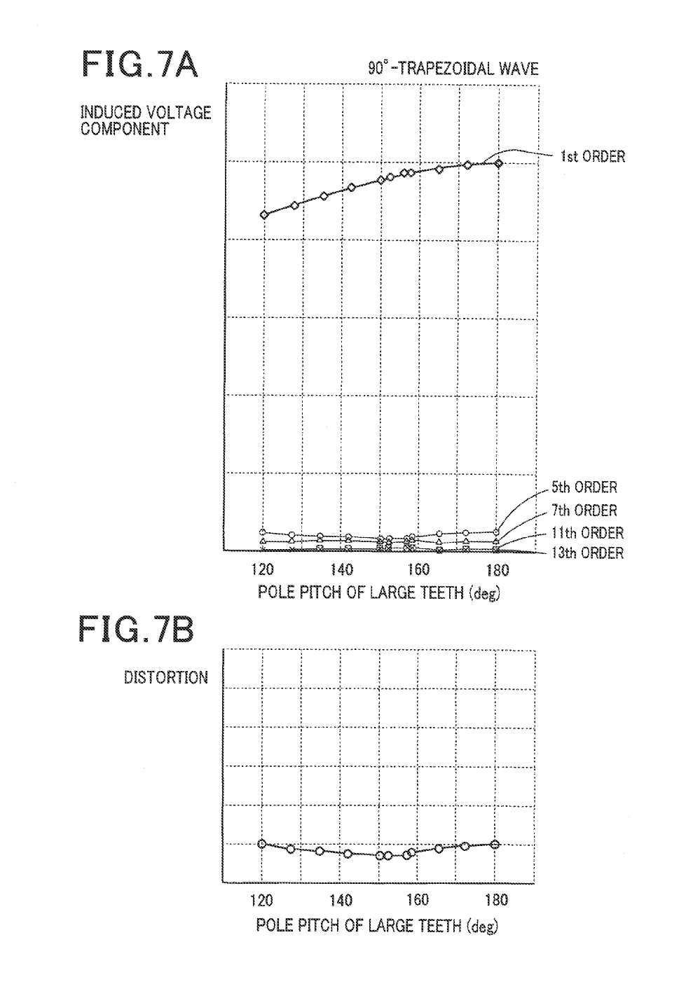

FIGS. 2 to 4 show the levels of the fundamental (first), fifth, seventh, eleventh and thirteenth harmonic components of the flux wave for each the above three cases. For each of the above three cases, a correlation between the value of the pole pitch X and the level of the induced voltage was obtained for each of the components of the first, fifth, seventh eleventh and thirteenth order (see FIGS. 5A, 6A and 7A).

Thereafter, a correlation between the distortion and the value of the pole pitch X was obtained for each of the above three cases (see FIGS. 5B, 6B and 7B). From the test, it was found that the distortion becomes minimum when the pole pitch X is approximately 156 degrees for all of the above three cases.

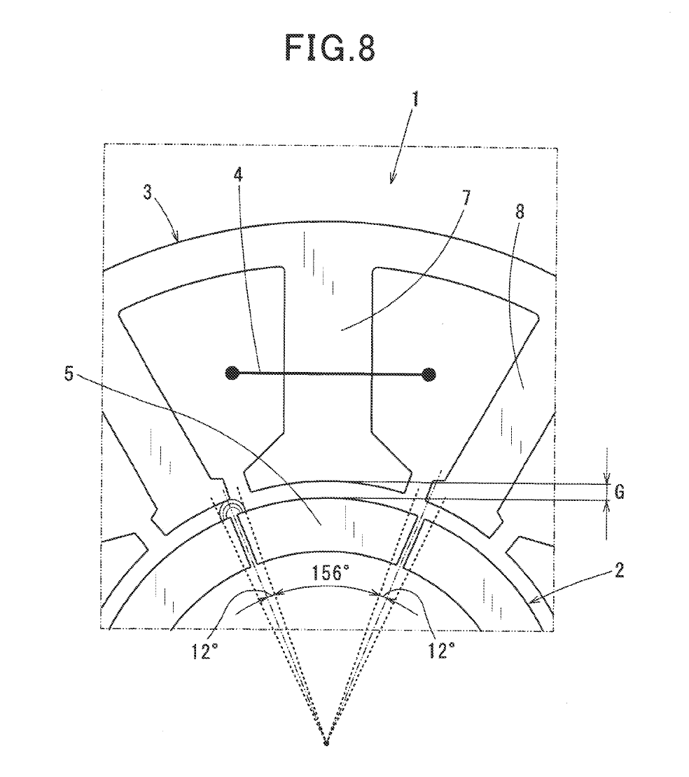

Accordingly, in this embodiment, the pole pitch X is set to 156 degrees to minimize the induced voltage distortion due to the harmonic components of the flux wave. Incidentally, as shown in FIG. 8, the radial distance G between the rotor 2 and the stator is set smaller than the value equivalent to 12 (=(180−X)/2=(180−156)/2) degrees in electrical angle of the circumferential width of the permanent magnet 5, so that the magnetic flux generated by one permanent magnet 5 except the area included in the 12-degree width area between circumferential ends of the adjacent permanent magnets 5 is not short-circuited.

The electric motor 1 described above provides the following advantages. The windings 4 of the stator 3 are supplied with a three-phase current, and the stator 3 includes the (3/2)×4×P large teeth 7 with the large pole pitch X and the (3/2)×4×P small teeth 8 with the small pole pitch Y (<X) which are disposed so as to circumferentially alternate. The windings 4 are wound concentratedly only on the large teeth 7. The pole pitch X of the large teeth 7 is 156 degrees in electrical angle, and the circumferentially adjacent winding 4 are supplied with currents having a phase difference of 120 degrees in electrical angle therebetween.

Accordingly, the harmonic components of the flux wave can be reduced without degrading the periodicity of the pole arrangement of the stator 3. In a conventional electric motor, since its windings are wound on all the teeth, the pole pitch is determined uniquely in accordance with the number of the poles divided by the number of the slots thereof, it is very difficult to set the pole pitch in view of reducing the harmonic components.

According to this embodiment, since the large teeth 7 on which the windings 4 are wound and the small teeth 8 on which the windings 4 are not wound are disposed so as to circumferentially alternate, it is possible to set the pole pitch X of the large teeth to a desired value regardless of the value of the number of the poles divided by the number of the slots . This makes it possible to set the pole pitch X so as to reduce the harmonic components of the flux wave. Therefore, the pole pitch X is set to 156 degrees to minimize the distortion. Hence, according to this embodiment, the harmonic components of the flux wave can be reduced to minimize the distortion of the induced voltage without degrading the periodicity of the pole arrangement of the stator 3.

The number P of the pole pairs is set to four. This makes it possible to set the number of the large teeth 7 of the same phase to 2 so that the poles of the same phase are opposite to each other to thereby reduce the vibration and noise due to the radial force of the electric motor 1.

The rotor 2 is of the surface magnet type. This increases the effect of reduction of the induced voltage distortion. If the rotor 2 is of the embedded magnet type, since the magnetic flux of each embedded magnet can flow in any direction within the magnetic part of the rotor 2, the effect of reduction of the induced voltage distortion becomes small. In this embodiment, since the rotor 2 is of the surface magnet type, the magnetic flux of the permanent magnets 5 is transferred directly between the outer peripheral surfaces of the permanent magnets 5 and the large teeth 7 or small teeth 8, the effect of reduction of the induced voltage distortion can be increased.

The radial distance G between the rotor 2 and the stator 3 is set smaller than the value equivalent to 12 degrees of the circumference width in electrical angle of the permanent magnet 5. Accordingly, the magnetic flux is transferred directly between the outer peripheral surface of the permanent magnet 5 and the large teeth 7 or small teeth 8 at least within the 156 degree-width area 156 whose center of symmetry is at the position of 90 degrees in electrical angle of the permanent magnet 5. Hence, setting the pole pitch X to 156 degrees makes it possible to maximize the effect of reduction of the induced voltage distortion.

### MODIFICATIONS

The above described embodiment can be modified in various ways as described for example. In the above embodiment, the pole pitch X is set to 156 degrees in electrical angle in view of minimizing the distortion. However, the pole pitch X may be set to any value in the range from 144 to 180 (preferably 144 to 166.2) degrees.

For example, when the harmonic component of the fifth order has to be reduced as much as possible, the pole pitch X may be set to 144 degrees. Likewise, when the harmonic components of the seventh, eleventh or thirteenth order has to be reduced as much as possible, the pole pitch X may be set to 154.3, 163.6 and 166.2 degrees, respectively. Further, when the harmonic component of the n-th order (n being an integer larger than 13) has to be reduced as much as possible, the pole pitch X may be set to {180−(360/n/2)} degrees.

In the above embodiment, the number P of the pole pairs is four. However, it may be a natural number other than four, preferably a natural number larger than four in view of reducing the vibration and noise due to the radial force of the electric motor 1. For example, when the number P of the pole pairs is six, eight or ten, the large teeth 7 of the same phase are disposed at an interval of 120 degrees, 90 degrees, or 60 degrees in mechanical angle, respectively, to ensure the symmetry of the radial force.

In the above embodiment, the distance G in the radial direction between the rotor 2 and the stator 3 is set smaller than the value equivalent to 12 degrees of the circumference width in electrical angle of the permanent magnet 5. However, the distance G may be changed in accordance with the value of the pole pitch X.

For example, when the pole pitch X is set to 144 degrees in electrical angle in view of reducing the harmonic component of the fifth order, the distance G may be set smaller than the value equivalent to 18 degrees in electrical angle of the circumferential width of the permanent magnet 5. In the above embodiment, the rotor 2 is of the surface magnet type. However, the rotor 2 may be of the embedded magnet type. The electric motor 1 described above is of the inner rotor type. However, the invention is also applicable to an outer rotor type.

The above explained preferred embodiments are exemplary of the invention of the present application which is described solely by the claims appended below. It should be understood that modifications of the preferred embodiments may be made as would occur to one of skill in the art.

What is claimed is:

1. An electric motor comprising:
a rotor including magnetic poles whose number of pole pairs is P, P being a natural number; and
a stator including windings,
wherein
the stator includes (3/2)×P large teeth with a first pole pitch and 3/2×P small teeth with a second pole pitch smaller than the first pole pitch, the large teeth and the small teeth being disposed so as to circumferentially alternate,
the windings are wound concentratedly only on the large teeth,
when the first pole pitch in electrical angle is X, X is in a range from 144 to 180 degrees,
when the second pole pitch in electrical angle is Y, Y is equal to (240−X) degrees, and
the circumferentially adjacent windings are supplied with currents having a phase difference of 120 degrees in electrical angle therebetween, respectively.

2. The electric motor according to claim 1, wherein the first pole pitch X is in a range from 144 to 166.2 degrees.

3. The electric motor according to claim 2, wherein the number P of the pole pairs is four or larger.

4. The electric motor according to claim 1, wherein the rotor is of the surface magnet type.

5. The electric motor according to claim 4, wherein a radial distance between the rotor and the stator is smaller than a value equivalent to {(180−X)/2} degrees of circumferential width in electrical angle of a magnet of the rotor.
